(19) United States
(12) Patent Application Publication
(10) Pub. No.: US 2005/0286639 A1
(43) Pub. Date: Dec. 29, 2005

(54) Pause and freeze for digital video streams

(75) Inventors: Gaurav Aggarwal, Bangalore (IN); M.K. Subramanian, Bangalore (IN); Sandeep Bhatia, Bangalore (IN); Santosh Savekar, Bangalore (IN); K. Shivapirakasan, Bangalore (IN)

Correspondence Address: MCANDREWS HELD & MALLOY, LTD, 500 WEST MADISON STREET, SUITE 3400, CHICAGO, IL, 60661, US

(73) Assignee: Broadcom Corporation

(21) Appl. No.: 10/874,634

(22) Filed: Jun. 23, 2004

(51) Int. Cl. H04B 1/66; H04N 11/02; H04N 11/04; H04N 7/12

(52) U.S. Cl. 375/240.25; 375/240.26

(57) ABSTRACT

Presented herein are systems and methods for pause and freeze functions for digital video streams. A particular picture is displayed for a plurality of video display periods. A next picture is displayed at the video display period immediately following the plurality of video display periods, the next picture immediately following the particular picture in a display order. A system clock reference is loaded with a time stamp associated with the next picture when displaying the next picture.

### RELATED APPLICATIONS

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Television (TV) content distribution is quickly migrating from analog formats to compressed digital formats. Currently, distribution of digital video content for TV display is dominated by use of the MPEG-2 video compression standard (ISO/IEC 13818-2). MPEG-2 and its predecessor MPEG-1 define the standards to compress video content using a combination of various techniques. An MPEG-encoded stream may have three types of pictures, Intra-coded (I), Predicted (P) and Bi-directionally predicted (B) . I-pictures are not compressed using any temporal predictions and can be decoded without the need of any other picture. The P-pictures perform temporal predictions from a picture that comes before it in the display order. Thus, decode of a P-pictures requires one picture (from the past) to be available with the decoder for performing temporal predictions. This prediction picture may be either an I-picture or another P-picture. The B-pictures are bi-directionally predicted and, hence, use two pictures for prediction, one from the past and another from the future (in display order).

During normal decode of MPEG streams, video decoders store the last two decompressed I/P pictures in memory. The last I/P picture is used for predicting an incoming P-picture and the last two I/P pictures are used for predicting an incoming B-picture.

However, additional functions allow the user to control the presentation of the video data. These functions include pause, freeze, slow motion, and high speed. The pause function stops the video during video playback. The video does not move forward and the last displayed picture is continuously redisplayed until the user releases the pause. When the user releases the pause, playback of the video resumes from the point from where it was paused. The video freeze freezes a picture from a streaming broadcast (in contrast to video from a storage device). Since the video is streaming, when the user releases the freeze, play is resumed from the point where the freeze is released. The video to be displayed between the freeze and the freeze release is lost.

During a pause or a freeze, a frame buffer storing the picture that is displayed is locked to prevent overwriting. In some decoder systems, there are three frames buffers. Where one of the frame buffers is locked, only two frame buffers remain for writing. In the case of B-pictures, where the B-picture is predicted from two reference pictures, there are not enough frame buffers to write the B-picture.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

These and other advantageous and novel features as well as details of illustrated embodiments will be more fully understood from the following description and drawings.

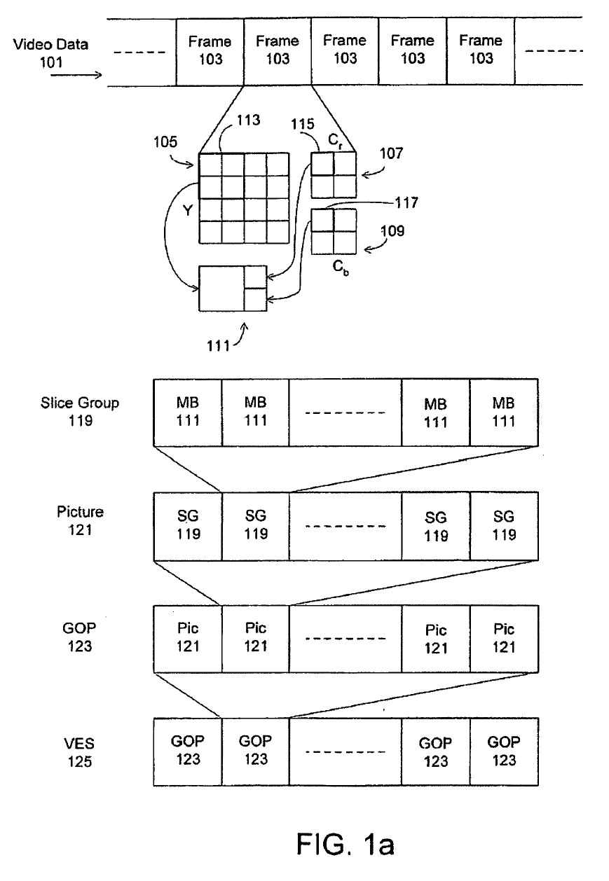

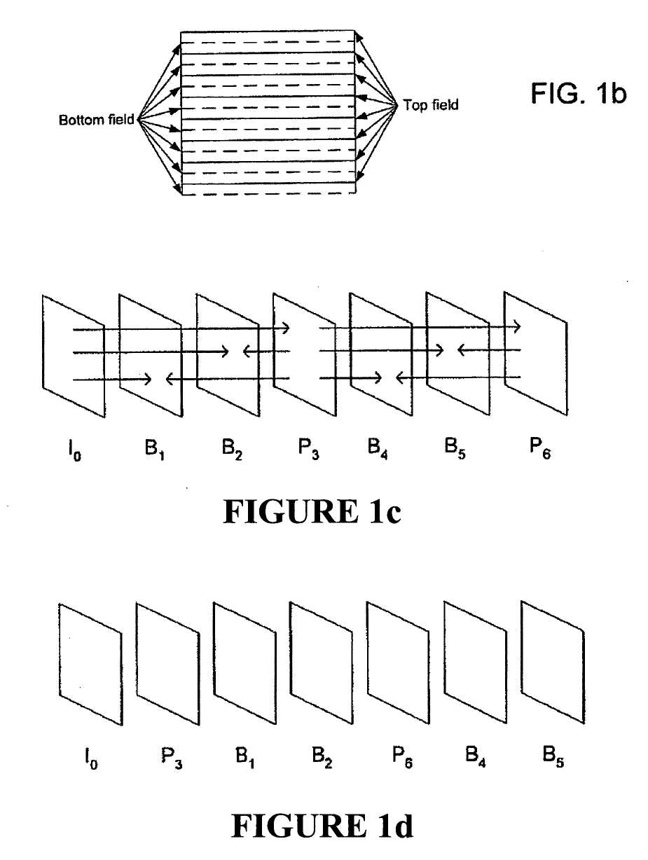

FIG. 1a illustrates a block diagram of an exemplary Moving Picture Experts Group (MPEG) encoding process, in accordance with an embodiment of the present invention.

FIG. 1b illustrates an exemplary interlaced frame, in accordance with an embodiment of the present invention.

FIG. 1c illustrates an exemplary sequence of frames in display order, in accordance with an embodiment of the present invention.

FIG. 1d illustrates an exemplary sequence of frames in decode order, in accordance with an embodiment of the present invention.

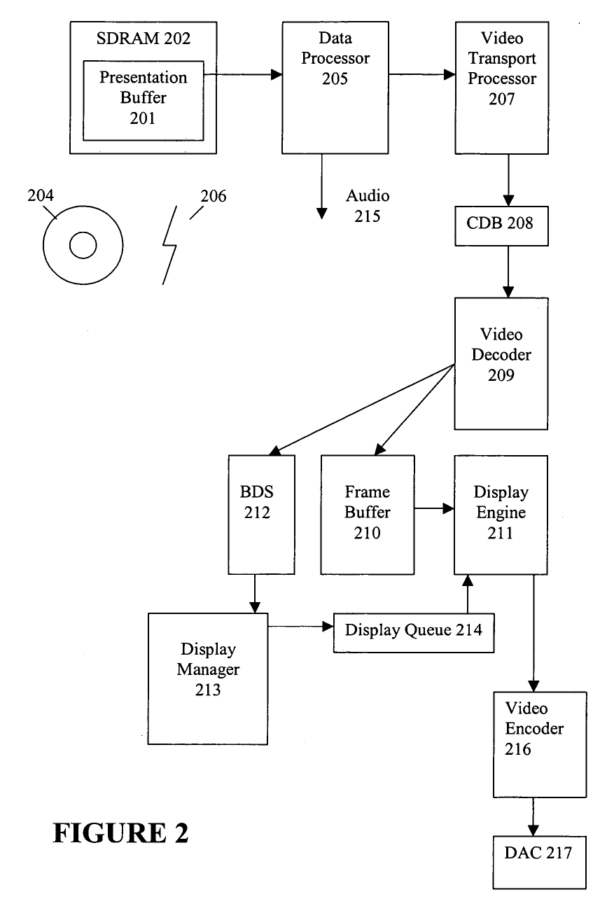

FIG. 2 is a block diagram of a decoder system in accordance with an embodiment of the present invention.

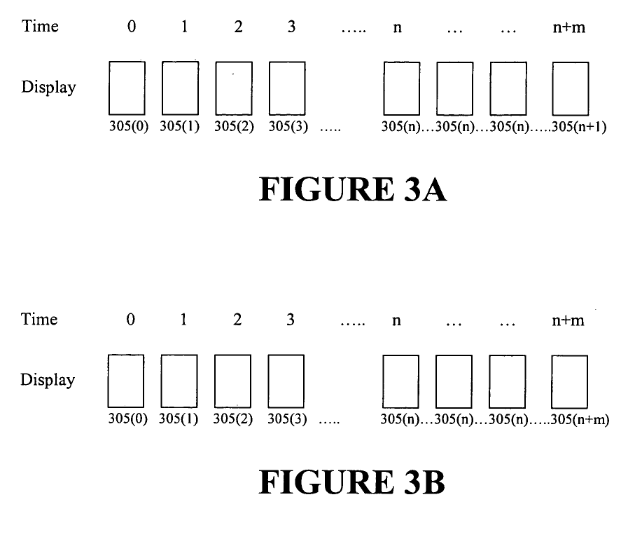

FIG. 3a is a block diagram describing the pause function.

FIG. 3b is a block diagram describing the freeze function.

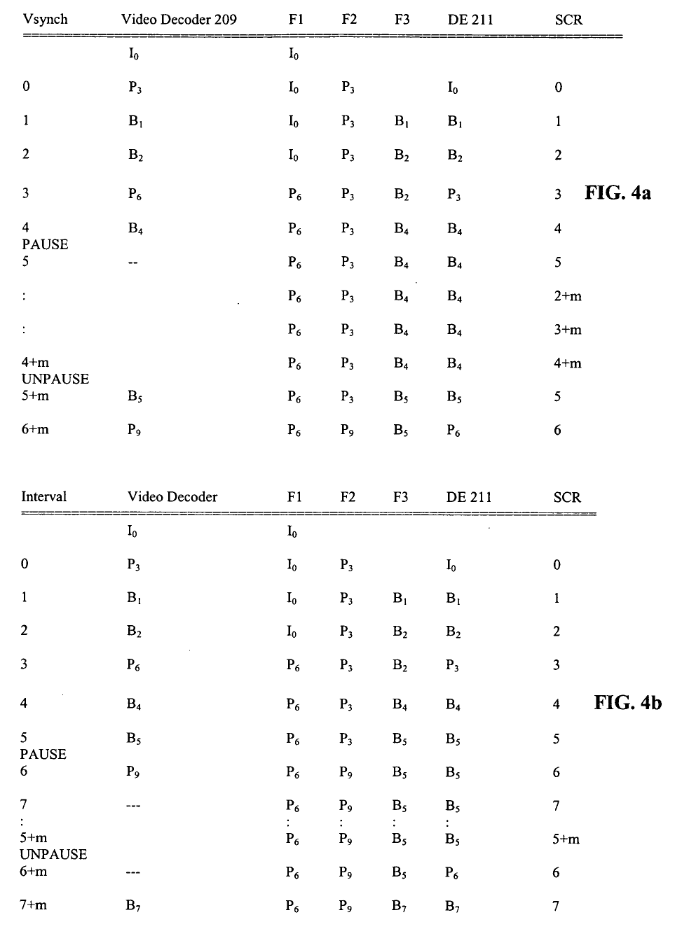

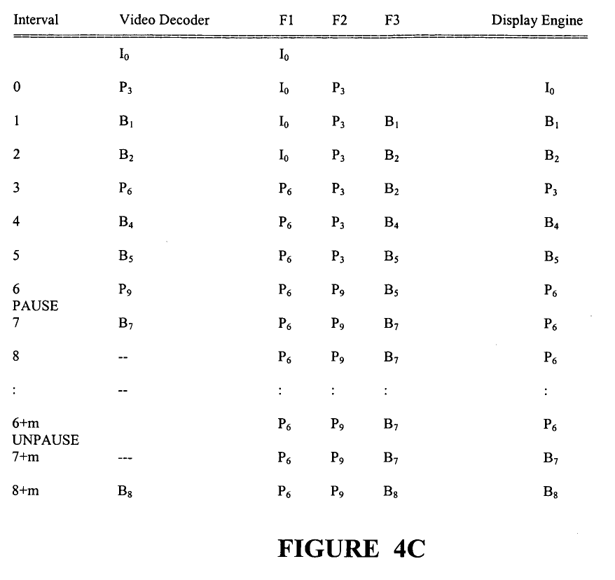

FIG. 4a is a timing diagram describing the operation of the decoder system in accordance with an embodiment of the present invention during the pause function;

FIG. 4b is a timing diagram describing the operation of the decoder system in accordance with another embodiment of the present invention during the pause function;

FIG. 4c is a timing diagram describing the operation of the decoder system in accordance with another embodiment of the present invention during the pause function; and

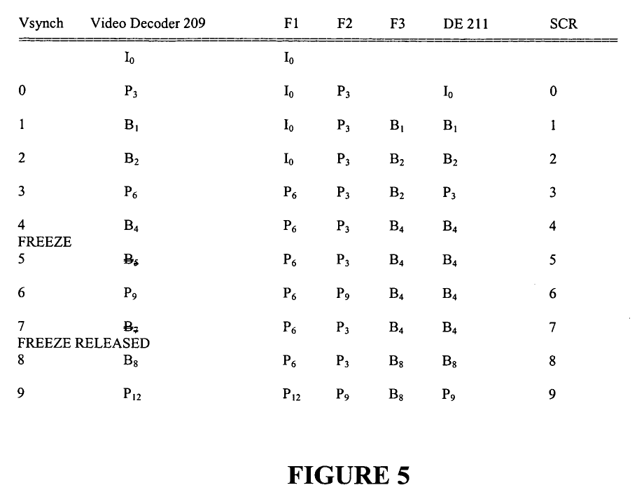

FIG. 5 is a timing diagram describing the operation of the decoder system in accordance with an embodiment of the present invention during the freeze function.

### BRIEF DESCRIPTION OF SEVERAL VIEWS OF THE DRAWINGS

Presented herein are systems and methods for pause and freeze functions for digital video streams.

In one embodiment, there is presented a method for displaying video data. The method comprises displaying a particular picture for a plurality of video display periods; displaying a next picture at the video display period immediately following the plurality of video display periods, the next picture immediately following the particular picture in a display order; and loading a system clock reference with a time stamp associated with the next picture when displaying the next picture.

In another embodiment, there is presented a system for displaying video data. The system comprises a display engine and a system clock reference. The display engine displays a particular picture for a plurality of video display periods and for displaying a next picture at the video display period immediately following the plurality of video display periods, the next picture immediately following the particular picture in a display order. The system clock reference indicates system timing information, the system clock reference loading a time stamp associated with the next picture when the display engine displays the next picture.

In another embodiment, there is presented a method for displaying video data. The method comprises displaying a particular picture for a plurality of video display periods; determining pictures to be decoded during each of the plurality of video display periods; and decoding the pictures to be decoded, wherein the pictures to be decoded are data dependent on one or less reference pictures, thereby resulting in decoded pictures.

In another embodiment, there is presented a system for displaying video data. The system comprises a video decoder and a display engine. The video decoder determines pictures to be decoded during each of the plurality of video display periods and decoding the pictures to be decoded, wherein the pictures to be decoded are data dependent on one or less reference pictures, thereby resulting in decoded pictures. The display engine displays a particular picture for a plurality of video display periods.

A better understanding of the invention can be obtained when the following detailed description of various exemplary embodiments is considered in conjunction with the following drawings.

### DETAILED DESCRIPTION OF THE INVENTION

The present invention relates to video recorder and playback systems, and more particularly to controlling the presentation of content.

FIG. 1a illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cᵣ, 107, and chrominance blue C_{b}, 109, pixels.

FIG. 1b is an illustration of a frame 103. A frame 103 can either be captured as an interlaced frame or as a progressive frame. In an interlaced frame 103, the even-numbered lines are captured during one time interval, while the odd-numbered lines are captured during an adjacent time interval. The even-numbered lines form the top field, while the odd-numbered lines form the bottom field of the interlaced frame.

Similarly, a display device can display a frame in progressive format or in interlaced format. A progressive display displays the lines of a frame sequentially, while an interlaced display displays one field followed by the other field. In a special case, a progressive frame can be displayed on an interlaced display by displaying the even-numbered lines of the progressive frame followed by the odd-numbered lines, or vice versa.

Referring again to FIG. 1a, the two-dimensional grids are divided into 8×8 blocks, where a group of four blocks or a 16×16 block 113 of luminance pixels Y is associated with a block 115 of chrominance red Cᵣ, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 103 (reference frames). When an appropriate (most similar, i.e. containing the same object(s)) portion of a reference frame 103 is found, the differences between the portion of the reference frame 103 and the macroblock 111 are encoded. The location of the portion in the reference frame 103 is recorded as a motion vector. The encoded difference and the motion vector form part of the data structure encoding the macroblock 111. In the MPEG-2 standard, the macroblocks 111 from one frame 103 (a predicted frame) are limited to prediction from portions of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

I₀, B₁, B₂, P₃, B₄, Bs, P₆, B₇, B₈, P₉, in FIG. 1c, are exemplary pictures. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures), for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The foregoing data dependency among the pictures requires decoding of certain pictures prior to others. Additionally, the use of later pictures as reference pictures for previous pictures requires that the later picture is decoded prior to the previous picture. As a result, the pictures cannot be decoded in temporal display order, i.e. the pictures may be decoded in a different order than the order in which they will be displayed on the screen. Accordingly, the pictures are transmitted in data dependent order, and the decoder reorders the pictures for presentation after decoding. I₀, P₃, B₁, B₂, P₆, B₄, B₅, P₉, B₆, B₇, in FIG. 1d, represent the pictures in data dependent and decoding order, different from the display order seen in FIG. 1c.

Referring again to FIG. 1a, the pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. The packetized elementary stream includes parameters, such as the decode time stamp and the presentation time stamp. Each packet is then associated with a transport header, forming what are known as transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

Referring now to FIG. 2, there is illustrated a block diagram of an exemplary circuit for decoding the compressed video data, in accordance with an embodiment of the present invention. A presentation buffer 201 within a Synchronous Dynamic Random Access Memory (SDRAM) 202 receives a transport stream. The presentation buffer 201 can receive the transport stream, either from a storage device 204, such as, for example, a hard disc or a DVD, or a communication channel 206.

A data transport processor 205 demultiplexes the transport stream into audio transport streams and video transport streams. The data transport processor 205 provides the audio transport stream to an audio portion 215 and the video transport stream to a video transport processor 207. The video transport processor 207 parses the video transport stream and recovers the video elementary stream. The video transport processor 207 writes the video elementary stream to a compressed data buffer 208. A video decoder 209 reads the video elementary stream from the compressed data buffer 208 and decodes the video. The video decoder 209 decodes the video on a picture by picture basis. When the video decoder 209 decodes a picture, the video decoder 209 writes the picture to a frame buffer 210.

The video decoder 209 receives the pictures in decoding order. However, as noted above, the decoding and displaying orders can be different. Accordingly, the decoded pictures are stored in frame buffers 210 to be available at display time. At display time, display engine 211 scales the video picture, renders the graphics, and constructs the complete display. Once the display is ready to be presented, it is passed to a video encoder 216 where it is converted to analog video using an internal digital to analog converter (DAC). The digital audio is converted to analog in an audio digital to analog converter (DAC) 217.

The frame buffers 210 also allow the video decoder 209 to predict predicted pictures from reference pictures. The decoder 209 decodes at least one picture, I₀, B₁, B₂, P₃, B₄, B₅, P₆, B₇, B₈, P₉, during each frame display period, in the absence of Personal Video Recording (PVR) modes when live decoding is turned on. Due to the presence of the B-pictures, B₁, B₂, the decoder 209 decodes the pictures, I₀, B₁, B₂, P₃, B₄, B₅, P₆, B₇, B₈, P₉ in an order that is different from the display order. The decoder 209 decodes each of the reference pictures, e.g., I₀, P₃, prior to each picture that is predicted from the reference picture. For example, the decoder 209 decodes I₀, B₁, B₂, P₃, in the order, I₀, P₃, B₁, and B₂. After decoding I₀ and P₃, the decoder 209 applies the offsets and displacements stored in B₁ and B₂, to the decoded I₀ and P₃, to decode B₁ and B₂. The frame buffers 210 store the decoded pictures, I₀ and P₃, in order for the video decoder 209 to decode B₁ and B₂.

The video decoder 209 also writes a number of parameters associated with each picture in a buffer descriptor structure 212. Each frame buffer 210 is associated with a buffer descriptor structure 212. The buffer descriptor structure 212 associated with a frame buffer 210 stores parameters associated with the picture stored in the frame buffer 210. The parameters can include, for example presentation time stamps.

A display manager 213 examines the buffer descriptor structures, and on the basis of the information therein, determines the display order for the pictures. The display manager 213 maintains a display queue 214. The display queue 214 includes identifiers identifying the frame buffers 210 storing the pictures to be displayed. The display engine 211 examines the display queue 214 to determine the next picture to be displayed.

The display manager 213 can determine the next picture to be displayed by examining the PTS parameters associated with the pictures. The display manager 213 can compare the PTS values associated with pictures to a system clock reference (SCR) to determine the ordering of the pictures for display.

Alternatively, the display manager 213 can also determine the order of the pictures to be displayed by examining the type of pictures decoded. In general, when the video decoder 209 decodes a B-picture, the B-picture is the next picture to be displayed. When the video decoder 209 decodes an I-picture or P-picture, the display manager 213 selects the I-picture or P-picture that was most recently stored in the frame buffer 210 to be displayed next.

A particular one of the frame buffers 210 stores B-pictures, while two other frame buffers 210 store I-pictures and P-pictures. When the video decoder 209 decodes a B-picture, the video decoder 209 writes the B-picture to the particular frame buffer 210 for storing B-pictures, thereby overwriting the previously stored B-picture. When the video decoder 209 decodes an I-picture or a P-picture, the video decoder 209 writes the I-picture or P-picture to the frame buffer 210 storing the I-picture or P-picture that has been stored for the longest period of time, thereby overwriting the I-picture or P-picture.

The circuit also supports a number of functions allowing the user to control the presentation of the video. These functions include pause and freeze. The pause function allows a user to constantly display a particular picture from a video stored in a storage device 204. The freeze function allows a user to constantly display a particular picture from a video received from a communication channel 206. Although the pause function and the freeze function allow the user to constantly display a particular picture, the functions are different when the pause or freeze is released. When the pause is released, play resumes from the point at which the pause occurred. When the freeze is released, play resumes at the point where the freeze was release.

Referring now to FIG. 3, there is illustrated a block diagram describing the pause and freeze functions. FIG. 3A describes the pause function. During regular play, the pictures 305(0) . . . 305(n) are displayed at video display periods 0 . . . n. A video display period corresponds to the time period that one picture is displayed. For example, with a progressive display, a video display period corresponds to the period between subsequent vertical synchronization pulses. For an interlaced display, the video display period corresponds to the period between a alternating vertical synchronization pulses. At video display period n, the user initiates the pause function.

Accordingly, at times n+1 until the user releases the pause function, e.g., n+m, the display engine 211 provides picture 305(n) for display. At time n+m, the user releases the pause function. Upon release of the pause function, the next picture at the time of the pause is displayed. Therefore, at time n+m+1, the display engine 211 provides picture 305 (n+1) for display.

FIG. 3B describes the freeze function. During regular play, the pictures 305(0) . . . 305(n) are displayed at times 0 . . . n. However, at time n, the user initiates the freeze function. Accordingly, at times n+1 until the user releases the freeze function, e.g., n+m, the display engine 211 provides picture 305(n) for display. At time n+m, the user releases the freeze function. Upon release of the freeze function at time n+m, the picture to be displayed at the time of the release is displayed. Therefore, at time n+m+1, the display engine 211 provides picture 305(n+m+1) for display.

Referring now to FIG. 4, there are illustrated timing diagrams describing the operation of the circuit during the pause function in accordance with an embodiment of the present invention. FIG. 4A describes the operation of the circuit when the pause function occurs during a B-picture that is followed by another B-picture in accordance with an embodiment of the present invention. FIG. 4B describes the operation of the circuit when the pause function occurs during a B-picture that is followed by a P-picture. FIG. 4C describes the operation of the circuit when the pause function occurs during an I-picture or P-picture. The foregoing operations will be described with the exemplary pictures illustrated in FIG. 1c.

Referring now to FIG. 4A, prior to Vsynch 0, picture I₀ is previously decoded and stored in frame buffer F1. At Vsynch 0, the video decoder 209 decodes P₃ and writes P₃ to frame buffer F2 and display engine 211 displays I₀. The pictures decoded by video decoder 209, stored in frame buffers F1, F2, and F3, and displayed by display engine are as shown. It is noted that there is a lag between the video decoder 209 and the display engine 211, and accordingly, the video decoder 209 decodes the indicated picture at a time corresponding to the indicated Vsynch minus the lag.

Between Vsynch 4 and 5, the user selects the pause function. During Vsynch 4, the picture B₄ is displayed. Accordingly, at each subsequent Vsynch, until Vsynch 5+m, the display engine 211 displays picture B₄. The display engine 211 stops reading from the display queue 214. The display manager 213 detects the foregoing and stops loading the display queue 214.

Additionally, when the display engine 211 displays picture B4, the frame buffer F3 locks, preventing the video decoder 209 from writing to the frame buffer F3. At Vsynch 5, the video decoder 209 is to decode picture B₅ and store picture B₅ to frame buffer F3. However, the video decoder 209 detects that frame buffer F3 is locked. Upon detecting that frame buffer F3 is locked, the video decoder 209 ceases decoding.

Since the video decoder 209 does not decode more pictures, the video decoder 209 stops evacuating data from the compressed data buffer 208 that stores the compressed bitstream. The video bitstream is placed in this compressed data buffer by the video transport processor 207. Once the compressed data buffer becomes full, the video transport processor 207 detects the overflow and stops writing more data to the compressed data buffer 208. Additionally, the data transport processor 205 stops reading further data from the presentation buffer 201.

When the user releases the pause function, between Vsynch 4+m and 5+m, the video decoder 209 decodes the picture B5. The display manager 213 indicates that the next picture for display is picture B₅ in the display queue 214. The display engine 211 removes the next entry from the display queue 214 and displays picture B₅ during Vsynch 5+m. The video decoder 209 resumes decoding, and at Vsynch 6+m, decodes picture P9. Additionally, the system clock reference loads the presentation time stamp for picture B5.

The foregoing can also be applied in the case where the display device is interlaced. Where the display device is interlaced, the display device transmits Vsynchs for both the top field and the bottom field for each picture. During the Vsynch for the top field and the bottom fields, the respective field is displayed. During the pause, the top field and the bottom field of the pause picture, B₄ can be displayed continuously in alternating order.

Referring now to FIG. 4B, prior to Vsynch 0, picture I₀ is previously decoded and stored in frame buffer F1. At Vsynch 0, the video decoder 209 decodes P₃ and writes P₃ to frame buffer F2 and display engine 211 displays I₀. The pictures decoded by video decoder 209, stored in frame buffers F1, F2, and F3, and displayed by display engine are as shown. It is noted that there is a lag between the video decoder 209 and the display engine 211, and accordingly, the video decoder 209 decodes the indicated picture at a time corresponding to the indicated Vsynch minus the lag.

Between Vsynch 5 and 6, the user selects the pause function. During Vsynch 5, the picture B5 is displayed. Accordingly, at each subsequent Vsynch, until Vsynch 6+m, the display engine 211 displays picture B5. The display engine 211 stops reading from the display queue 214.

Additionally, when the display engine 211 displays picture B5, the frame buffer F3 locks. The video decoder 209 decodes picture P₉ and writes picture P₉ to frame buffer F2. The display manager 213 places an indicator in the display queue indicating that picture P₆ is the next picture to be displayed. At Vsynch 7, the video decoder 209 is to decode picture B7 and stores picture B7 to frame buffer F3. However, frame buffer F3 is locked. Upon detecting this, the video decoder 209 ceases decoding. The display manager 213 detects the foregoing and stops loading the display queue 214.

Since the video decoder 209 does not decode more pictures, the video decoder 209 stops evacuating data from the compressed data buffer 208 that stores the compressed bitstream. The video bitstream is placed in this compressed data buffer by the video transport processor 207. Once the compressed data buffer becomes full, the video transport processor 207 detects the overflow and stops writing more data to the compressed data buffer 208. Additionally, the data transport processor 205 stops reading further data from the presentation buffer 201.

When the user releases the pause function, between Vsynch 5+m and 6+m, picture P₆ is already decoded and stored in frame buffer F1. The display queue 214 indicates that the next picture for display is picture P6. The display engine 211 removes the next entry and from the display queue 214 and displays picture P₆ during Vsynch 6+m. The system clock reference loads the presentation time stamp for picture P6. Additionally, video decoder 209 resumes decoding, and at Vsynch 7+m, decodes picture B7.

The foregoing can also be applied in the case where the display device is interlaced. Where the display device is interlaced, the display device transmits Vsynchs for both the top field and the bottom field for each picture. During the Vsynch for the top field and the bottom fields, the respective field is displayed. During the pause, the top field and the bottom field of the pause picture, B5 can be displayed continuously in alternating order.

Referring now to FIG. 4C, prior to Vsynch 0, picture I₀ is previously decoded and stored in frame buffer F1. At Vsynch 0, the video decoder 209 decodes P₃ and writes P₃ to frame buffer F2 and display engine 211 displays Io. The pictures decoded by video decoder 209, stored in frame buffers F1, F2, and F3, and displayed by display engine are as shown. It is noted that there is a lag between the video decoder 209 and the display engine 211, and accordingly, the video decoder 209 decodes the indicated picture at a time corresponding to the indicated Vsynch minus the lag.

Between Vsynch 6 and 7, the user selects the pause function. During Vsynch 6, the picture P₆ is displayed. Accordingly, at each subsequent Vsynch, until Vsynch 7+m, the display engine 211 displays picture P6. The display engine 211 stops reading from the display queue 214.

Additionally, when the display engine 211 displays picture P6, the frame buffer F1 locks. The video decoder 209 decodes picture P₉ and writes picture P₉ to frame buffer F2. At Vsynch 7, the video decoder 209 decodes picture B₇ and stores picture B₇ to frame buffer F3. The display manager 213 places an indicator in the display queue 214 indicating that picture B7 is the next picture to be displayed. At Vsynch 8, the video decoder 209 is to decode picture B8. However, picture B₇ is not displayed. Upon detecting this, the video decoder 209 ceases decoding.

Since the video decoder 209 does not decode more pictures, the video decoder 209 stops evacuating data from the compressed data buffer 208 that stores the compressed bitstream. The video bitstream is placed in this compressed data buffer by the video transport processor 207. Once the compressed data buffer becomes full, the video transport processor 207 detects the overflow and stops writing more data to the compressed data buffer 208. Additionally, the data transport processor 205 stops reading further data from the presentation buffer 201.

When the user releases the pause function, between Vsynch 6+m and 7+m, picture B₇ is already decoded and stored in frame buffer F3. The display manager 213 indicates that the next picture for display is picture B₇ in the display queue 214. The display engine 211 removes the next entry and from the display queue 214 and displays picture B₇ during Vsynch 7+m. The video decoder 209 resumes decoding, and at Vsynch 8+m, decodes picture B8. The system clock loads the presentation time stamp from picture B8.

The foregoing can also be applied in the case where the display device is interlaced. Where the display device is interlaced, the display device transmits Vsynchs for both the top field and the bottom field for each picture. During the Vsynch for the top field and the bottom fields, the respective field is displayed. During the pause, the top field and the bottom field of the pause picture, P6 can be displayed continuously in alternating order.

The circuit also supports a freeze function. As noted above, upon releasing the freeze function, the picture to be displayed at the time the freeze function is released is displayed. However, the picture to be displayed may be predicted from reference pictures. Accordingly, the reference pictures for the picture to be displayed need to be decoded at the time the freeze function is released. However, the picture that is constantly displayed locks one of the frame buffers 210. As noted above, two decoded pictures in two frame buffers 210 are needed to decode a B-picture in a third frame buffer 210. If there are only three frame buffers 210, where one frame buffer 210 locks, there are not enough frame buffers 210 to decode B-pictures. Accordingly, during the freeze function, the video decoder 209 skips decoding B-pictures.

Referring now to FIG. 5, there is illustrated a timing diagram describing the operation of the circuit in accordance with an embodiment of the present invention during a freeze function. Prior to Vsynch 0, picture I₀ is previously decoded and stored in frame buffer F1. At Vsynch 0, the video decoder 209 decodes P₃ and writes P₃ to frame buffer F2 and display engine 211 displays I₀. The pictures decoded by video decoder 209, stored in frame buffers F1, F2, and F3, and displayed by display engine are as shown. It is noted that there is a lag between the video decoder 209 and the display engine 211, and accordingly, the video decoder 209 decodes the indicated picture at a time corresponding to the indicated Vsynch minus the lag.

Between Vsynch 4 and 5, the user selects the freeze function. Responsive thereto, the picture displayed during Vsynch 4, picture B4, is constantly displayed until the freeze function is released between Vsynch 7 and Vsynch 8. When the picture B₄ is constantly displayed, the frame buffer F3 locks. At Vsynch 5, the video decoder 209 is to decode picture B5. The video decoder 209 can determine the picture to be decoded in a number of different ways. For example, the video decoder 209 receives the pictures in decoding order. Accordingly, the video decoder can examine one picture during each video display period. Alternatively, the video decoder 209 can determine the picture to be decoded by comparing a parameter known as the display time stamp to the system clock reference.

The video decoder 209 skips decoding B-pictures during the video freeze. At Vsynch 6, the video decoder 209 decodes picture P₉ and stores picture P₉ in frame buffer F2. At Vsynch 7, the video decoder 209 skips decoding picture B₇.

Between Vsynch 7 and 8, the user releases the freeze function. At Vsynch 8, the video decoder 209 decodes and the display engine 211 displays picture B₈. The video decoder 209 can decode picture B₈ from pictures P₆ and P₉, because picture P₉ was decoded during the freeze at Vsynch 6. At Vsynch 9, the video decoder 209 decodes picture P₁₂ from picture P₉, while display engine 211 displays picture P₉.

The foregoing can also be applied in the case where the display device is interlaced. Where the display device is interlaced, the display device transmits Vsynchs for both the top field and the bottom field for each picture. During the Vsynch for the top field and the bottom fields, the respective field is displayed. During the pause, the top field and the bottom field of the pause picture, B₄ can be displayed continuously in alternating order.

The circuit as described herein may be implemented as a board level product, as a single chip, application specific integrated circuit (ASIC), or with varying levels of the system integrated on a single chip with other portions of the system as separate components. The degree of integration of the monitoring system may primarily be determined by speed of incoming MPEG packets, and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device wherein the memory storing instructions is implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for displaying video data, said method comprising:
displaying a particular picture for a plurality of video display periods;
displaying a next picture at the video display period immediately following the plurality of video display periods, the next picture immediately following the particular picture in a display order; and
loading a system clock reference with a time stamp associated with the next picture when displaying the next picture.

2. The method of claim 1, further comprising:
receiving a user input indicating a pause release.

3. The method of claim 1, further comprising:
writing the particular picture in a frame buffer; and
locking the frame buffer for the plurality of display periods.

4. The method of claim 3, further comprising:
decoding the next picture during a first one of the plurality of display periods.

5. A system for displaying video data, said system comprising:
a display engine for displaying a particular picture for a plurality of video display periods and for displaying a next picture at the video display period immediately following the plurality of video display periods, the next picture immediately following the particular picture in a display order; and
a system clock reference for indicating system timing information, the system clock reference loading a time stamp associated with the next picture when the display engine displays the next picture.

6. The system of claim 5, wherein the display engine displays the next picture after the system receives a user input indicating a pause release.

7. The system of claim 5, further comprising:
a frame buffer for storing the particular picture and locking for the plurality of display periods.

8. The system of claim 7, further comprising:
A video decoder for decoding the next picture during a first one of the plurality of display periods.

9. A method for displaying video data, said method comprising:
displaying a particular picture for a plurality of video display periods;
determining pictures to be decoded during each of the plurality of video display periods; and
decoding the pictures to be decoded, wherein the pictures to be decoded are data dependent on one or less reference pictures, thereby resulting in decoded pictures.

10. The method of claim 9, further comprising:
storing the particular picture in a frame buffer;
locking the frame buffer during the plurality of video display periods; and
writing the decoded pictures in other frame buffers.

11. The method of claim 10, further comprising:
displaying another picture from one of the other frame buffers during a video display period immediately following the plurality of video display periods, wherein the another picture is associated with a presentation time stamp corresponding to a system time associated with the video display period immediately following the plurality of video display periods.

12. The method of claim 10, further comprising:
decoding another picture that is data dependent on two or more of the pictures in the other frame buffers, immediately after the plurality of video display periods;
writing the another picture in the frame buffer; and
displaying the another picture during the video display period immediately following the plurality of video display periods, wherein the another picture is associated with a presentation time stamp corresponding to a system time associated with the video display period immediately following the plurality of video display periods.

13. A system for displaying video data, said system comprising:
a display engine for displaying a particular picture for a plurality of video display periods;
a video decoder for determining pictures to be decoded during each of the plurality of video display periods and decoding the pictures to be decoded, wherein the pictures to be decoded are data dependent on one or less reference pictures, thereby resulting in decoded pictures.

14. The system of claim 13, further comprising:
a frame buffer for storing the particular picture, said frame buffer locking during the plurality of video display periods; and
other frame buffers for storing the decoded pictures.

15. The system of claim 14, further comprising:
a system clock reference for indicating system time associated with the video display period immediately following the plurality of video display periods.

16. The system of claim 15 wherein the display engine displays another picture from one of the other frame buffers during a video display period immediately following the plurality of video display periods, wherein the another picture is associated with a presentation time stamp corresponding to the system time associated with the video display period immediately following the plurality of video display periods.

17. The system of claim 15, wherein the video decoder decodes another picture that is data dependent on two or more of the pictures in the other frame buffers, immediately after the plurality of video display periods; wherein the frame buffers stores the another picture; and wherein the display engine displays the another picture during the video display period immediately following the plurality of video display periods, wherein the another picture is associated with a presentation time stamp corresponding to a system time associated with the video display period immediately following the plurality of video display periods.
